(19) United States
(12) Patent Application Publication
(10) Pub. No.: US 2017/0200216 A1
(43) Pub. Date: Jul. 13, 2017

(54) SYSTEM AND METHOD TO OPTIMIZE PRODUCT PRICING AND INVENTORY MANAGEMENT UTLIZING AN ADVANCED PRICE FULFILLMENT DATE MATCHING PROCESS

(71) Applicants: Jeroen Stedehouder, Chicago, IL (US); Wouter Johannes Gerardus Wolken, Chicago, IL (US)

(72) Inventors: Jeroen Stedehouder, Chicago, IL (US); Wouter Johannes Gerardus Wolken, Chicago, IL (US)

(21) Appl. No.: 15/367,596

(22) Filed: Dec. 2, 2016

Related U.S. Application Data
(60) Provisional application No. 62/277,915, filed on Jan. 12, 2016.

(51) Int. Cl. G06Q 30/06; G06Q 20/10; G06Q 30/02; G06Q 10/08

(52) U.S. Cl. CPC G06Q 30/0633; G06Q 10/087; G06Q 20/102; G06Q 30/0283

(57) ABSTRACT

A system and method providing one or more sellers the ability to sell a plurality of homogeneous goods and/or services to one or more buyers utilizing an advanced fulfillment date/price matching process. Fulfillment date/price pairs for each good and/or service are generated by a machine comprising computing, comparative, and communication means as well as one or more data storage locations. Buyers then have the ability to submit an order, by selecting one of the generated price/fulfillment date pairs, to the system, whereafter the system notifies the seller, at the fulfillment date, to fulfill the order, inventory permitting. The method and system can be utilized by sellers who wish to optimize product pricing and inventory management, while providing buyers with an interactive way to reduce product purchasing cost.

### CROSS-REFERENCE TO RELATED APPLICATIONS

This application claims the benefit of U.S. Provisional Application No. 62/277,915, filed Jan. 12, 2015, entitled SYSTEM AND METHOD TO OPTIMIZE PRODUCT PRICING UTILIZING A SCHEDULED MARKDOWN PROCESS, by the present inventors, which is incorporated by reference.

### BACKGROUND OF THE DISCLOSURE

1. Field of the Invention

The present invention relates generally to systems and methods associated with online and offline commerce, and more particularly to providing a markdown method that can be applied via a computer network or in a brick and mortar store.

2. Description of the Background of the Disclosure

Various systems and methods have been developed for the buying and selling of goods and/or services over the Internet. Although most of these systems and methods provide for a solution in conducting e-commerce transactions, many shortcomings still exist in the current space of e-commerce. These systems and methods can, generally speaking, be split up in a few separate classes.

One class of systems and methods are those selling goods and/or services against a fixed price during an extended period of time, such as ordinary web shops. The markdown process of this conventional system and method of selling usually starts with offering the good and/or service at full price, followed by a time period in where the good and/or service is offered at a low discount, inventory permitting, followed by a time period in where the good and/or service is offered at a high discount, inventory permitting, followed by an eventual clearance and/or liquidation sale, inventory permitting, of the good and/or service. Although these conventional ways of selling goods and/or services have been the standard for many years, a few drawbacks still exist. One drawback stems from that fact that the markdown process happens in discrete steps, leading to suboptimal pricing of such goods and/or services, and a potential prolonged time during which these goods and/or services are sold either individually or collectively. This system and method of selling also does not engage the prospective buyer in the pricing aspect of the good and/or service, which could lead to a potential loss of sale as a result of the prospective buyer losing interest during the online purchasing process.

Another class of systems and methods are those selling goods and/or services at a fixed price during a short period of time, such as flash deal sites. This type of systems and methods often offer deep fixed discounts in order to generate sales. However, this system and method of selling lacks the ability to immediately adjust pricing of the goods and/or services based on direct supply and demand. As a result, this could lead to loss of sales or suboptimal pricing for which the goods and/or services are sold.

Another class of systems and methods are those selling goods and/or services at variable prices during a short period of time, such as auction sites, making offer platforms, flexible pricing platforms, etc. Auction sites as well as making offer platforms allow their prospective buyers to place a bid/make an offer on a variety of products during an allotted time period after which a winner is appointed. They lack the ability to establish a market price based on direct supply and demand for selling a multitude of homogeneous goods and/or services from one or more sellers to multiple buyers. Usually, auction sites and making offer platforms focus on the second hand market, making it also hard for the buyer to validate the state of the second hand good. Flexible pricing platforms, similar to auction sites and making offer platforms, lack the instant gratification aspect as these are primarily focused on matching one buyer, who inputs his/her own price, to one of the multiple sellers, who manually accept the buyer's inputted price.

Another class of systems and methods are those selling goods and/or services directly from a warehouse or factory. They lack the ability to efficiently manage their inventory as future orders are not available. Those sellers produce based on current supply and demand and frequently face overproduction or underproduction. As a result, budget, delivery, customer satisfaction, and inventory problems arise.

This application describes a useful, creative, novel and unobvious invention of selling a single or plurality of a homogeneous good and/or service from one or more sellers to one or more buyers in a fully automated fashion. This method of selling has numerous advantages, the first advantage being that multiple prospective buyers have the ability to buy a quantity of one or more of the same good and/or service by choosing/selecting one of the system generated flexible price/fulfillment date pairs, these pairs being merely a reflection of the buyer's preferred price, cost of holding inventory, and the good's and/or service's supply and demand. Here, the seller of the good and/or service sets the initial product listing date and basic pricing variables such as minimum and maximum price, from wherein the prospective buyer can select the system generated price/fulfillment date pair at which he/she wishes to acquire the good and/or service.

This manner of selling has a second advantage in that it saves the seller all of the work involved with the actual selling process of the good and/or service as the seller doesn't need to manually execute any transactions or either manually generate the flexible price/fulfillment date pairs. The third advantage has to do with the rate at which a seller's inventory is cleared; selling a multitude of goods and/or services through flexible demand-driven price/fulfillment date pair generation ensures price optimization of the goods and/or services at any time during the product selling cycle resulting in the seller's inventory to be cleared out at a much higher rate as opposed to any other traditional inventory clearing method. Another advantage of the invention is that it provides sellers with the ability to dynamically manage and/or manufacture inventory. Also, a flexible demand-driven price/fulfillment date pair system and method creates an interactive shopping experience for the prospective buyer; keeping the prospective buyer involved in the pricing process of a good and/or service leads to the generation of more sales as the probability of the prospective buyer completing the online purchasing process is much higher.

### SUMMARY OF THE INVENTION

In the preferred embodiments, this system and method of price setting comprises an advanced price/fulfillment date matching process, where based on an input price or a range of prices, an associated fulfillment date is being generated; the lower the price the later the fulfillment date.

In accordance with the present invention, a system and method for providing one or more sellers the ability to sell a single or plurality of homogeneous goods and/or services to one or more buyers is provided. It will be seen that in a preferred embodiment, the device and method comprise a machine comprising a central processing unit (CPU), rapid access memory (RAM), read only memory (ROM), a plurality of data storage locations, communications means, and peripherals, wherein the machine is capable of receiving and storing price/fulfillment date pairs and their associated payment information. In the operation of the method and device, one or more buyers secure a fulfillment date of a good and/or service and inputs payment credentials into the machine whereupon each fulfillment date is stored in one of the plurality of data storage locations and the associated payment information is stored in a payment information detail storage location.

The invention provides real-time pairing of prices and fulfillment dates, storing of price/fulfillment date pairs in the one or more data storage locations, execution of the stored price/fulfillment date pairs by notifying the seller at the fulfillment date that the goods and/or services need to be prepared for shipment/pickup, inventory permitting.

In addition, it will be seen that the machine of the invention can be one or more machines.

In preferred embodiments, the invention includes means to create complex relationships between the fulfillment date of a product and the buyer's preferred price. It will be understood that in the invention the pairing of the price/fulfillment dates is dependent on, but not limited to

1. A complex varying combination of supply, elasticity of demand, cost of holding inventory, consumer behavioral patterns, manufacturing and/or inventory schedules, etc.

2. A classification method, and/or a neural network, and/or a stochastic process.

Further, for the convenience of participants in the process, in preferred embodiments a buyer selects a price/fulfillment date pair using a price slider, or a price calendar comprised of a range of price/fulfillment date pairs falling within the seller's pre-specified minimum price/fulfillment date and a pre-specified maximum price/fulfillment date.

In some embodiments of the invention, operators of the invention can provide a standalone software system for use in a third party merchant/supplier/e-commerce website as an embedded additional feature of the website. In addition, the system and method can be configured for use in brick & mortar stores, through mobile applications and mobile web portals.

In preferred embodiment, buyers have the option to increase the value of a submitted price during the listing period.

For the convenience of the users, in preferred embodiments of the invention, payment information comprises one or more types of credit card information, bank routing and account information, or any other third party payment service information.

### ADVANTAGES

Accordingly several advantages of one or more aspects are as follows: to provide a flexible price driven system and method, that, in possible combination with other factors, has the functionality to generate and store price/fulfillment date pairs, that is able to sell a single or plurality of homogeneous new, excess or out of season goods and/or services to one or more buyers within the most optimal time period given a buyer's preferred price, that allows the product pricing cycle to be continuous, that is fully automated with regard to price/date pair generation and payment processing, and that allows for inventory to be dynamically managed and/or manufactured after order placement as opposed to in advance. Other advantages will become apparent from the consideration of the drawings and ensuing descriptions.

### BRIEF DESCRIPTION OF THE DRAWINGS

FIG. 1A is a flow diagram of a basic order placement and execution system and method, with customer order commitment, of the present disclosure;

FIG. 1B is a flow diagram of a basic order placement and execution system and method, without customer order commitment, of the present disclosure;

FIG. 1C is a flow diagram of a basic order placement and execution system and method, comprising the customer selecting, with or without order commitment, a price/fulfillment date pair generated by one or more sellers, of the present disclosure;

FIG. 1D is a flow diagram of a basic order placement and execution system and method, comprising customer order commitment and price/fulfillment date pair generation based on customer's input and seller's inventory levels, of the present disclosure;

FIG. 2 is a flow diagram of a machine having the capability to run the system and method of the present disclosure;

FIG. 3 illustrates a sample graphical user interface of the system and method of the present disclosure, specifying the retail price and the reserve my price option for both online merchants (section I) and offline merchants (section II);

FIG. 4 illustrates a sample webpage/app price/fulfillment date pair input screen of the system and method of the present disclosure;

FIG. 5 illustrates a sample webpage/app reserved order confirmation screen of the system and method of the present disclosure;

FIG. 6 illustrates a sample webpage/app product availability customer notification screen of the system and method of the present disclosure;

### DETAILED DESCRIPTION OF THE ILLUSTRATIVE EMBODIMENT

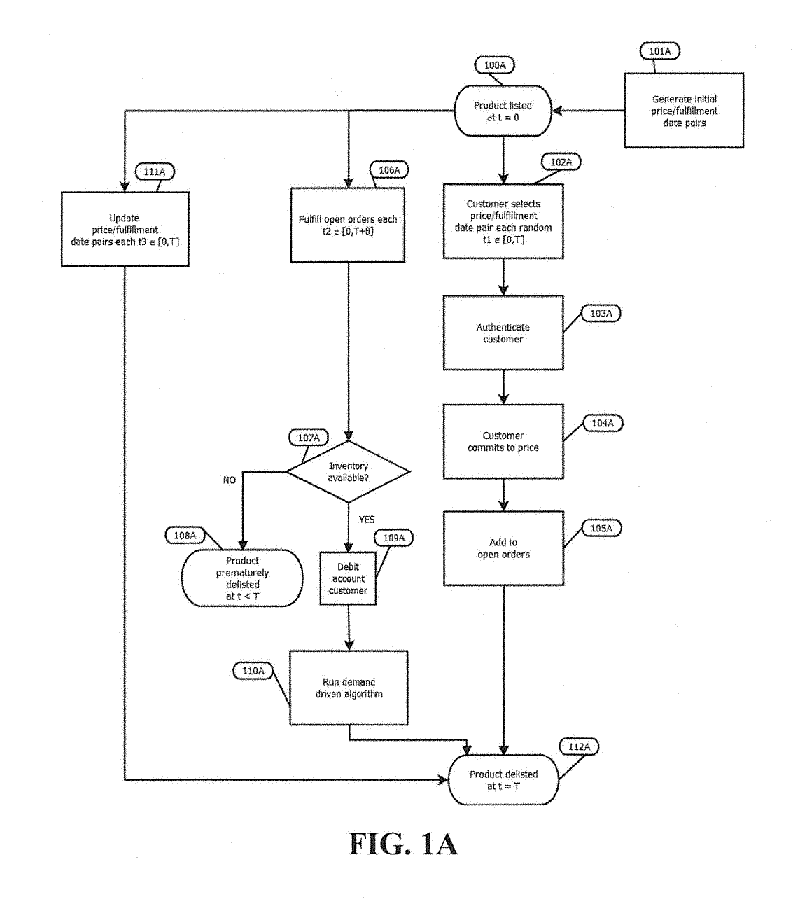

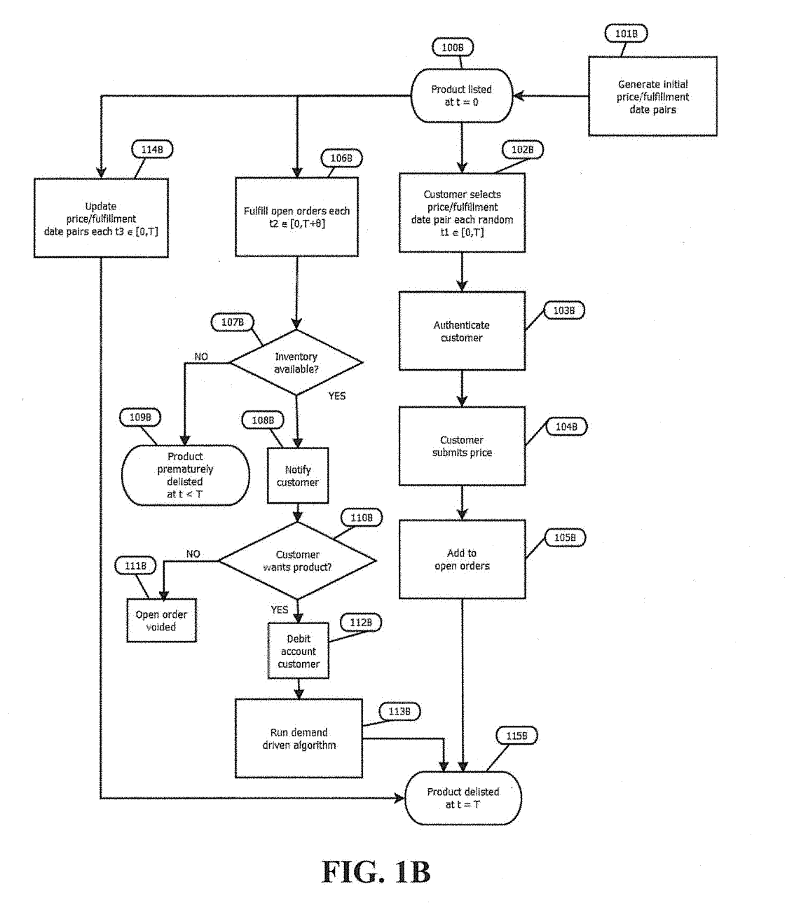

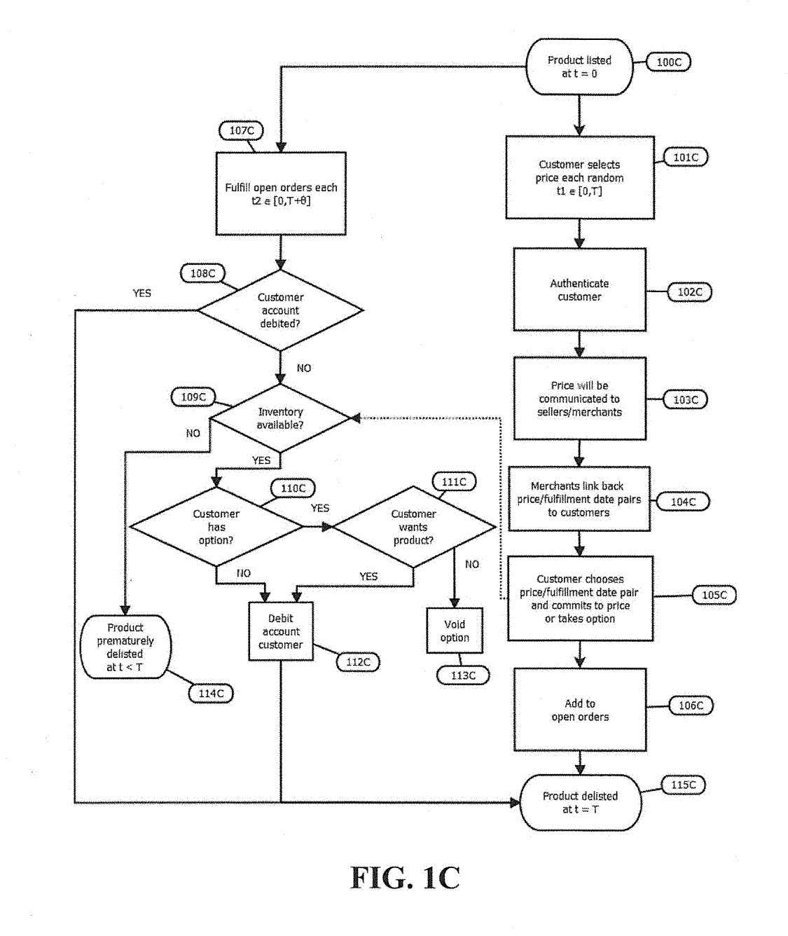

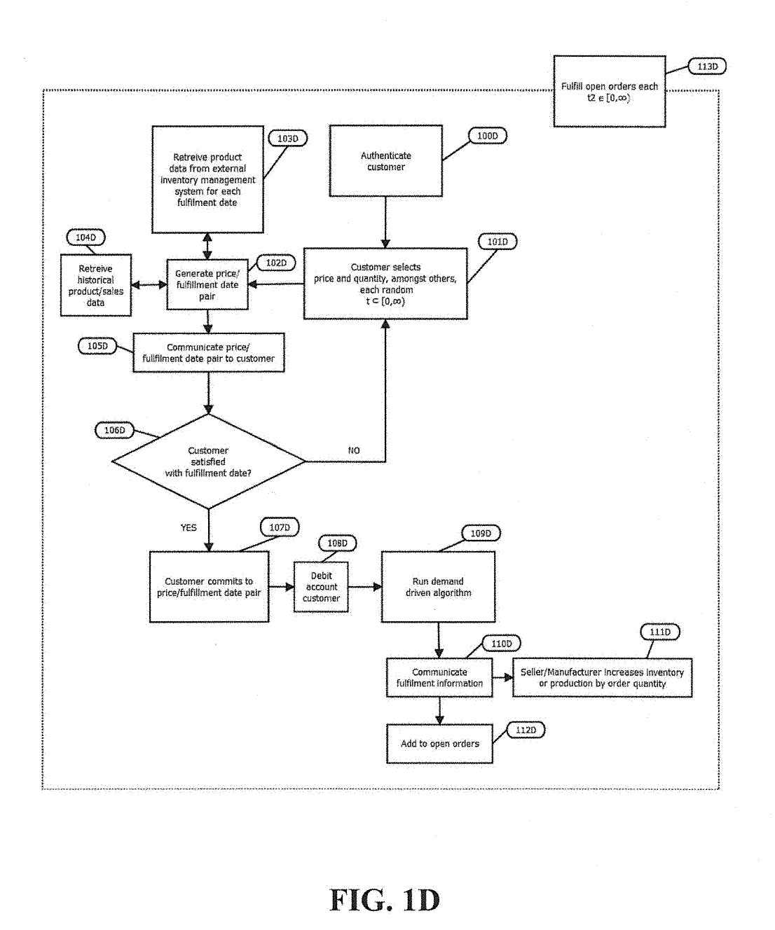

Referring now to FIGS. 1-6, exemplary embodiments of a system and method for improved online and offline selling are shown. In these exemplary embodiments, improved online and offline selling is achieved through a process of generating price/fulfillment date pairs and storing said price/fulfillment date pairs from one or more buyers through time.

FIG. 1A illustrates a basic process of an order placement and execution system, with customer order commitment, in one embodiment. A product is listed for sale utilizing the price/fulfillment date generation system and method at time t=0, as shown in block 100A. In block 101A, the price/fulfillment date generation system and method generates the initial price/fulfillment date pairs for the product listed in block 100A. It will be understood that instead of generating price/fulfillment date pairs, either price/fulfillment date range pairs, or price range/fulfillment date pairs, or price range/fulfillment date range pairs could be generated as well. For the purpose of simplicity, hereon after the only case referred to is the case where price/fulfillment date pairs are being generated. In block 102A customers select their preferred price/fulfillment date pair at any time after product listing at time t₁=0 and before product delisting at time t₁=T. Immediately after, the customer is authenticated through, but not limited to, a cell phone number, shipping address or email confirmation, as shown in block 103A. In block 104A, the customer commits to the price/fulfillment date pair by providing payment details. Once the customer committed to the price/fulfillment date pair, the commit will be added to the open/outstanding orders, as show in block 105A.

At any time between product listing at time t₂=0 and at or after product delisting at time t₂=T+θ, θ being some random time after t₂=T, θε[0,∞)εtime, the system and method collects open/outstanding orders for fulfillment at the fulfillment date, or within the fulfillment range, as shown in block 106A, whereafter the system will perform an inventory check, as shown in block 107A. The inventory check will check if the product is still available. If the product is still in stock, the system and method debits the account of the customer, block 109A. If the product is not in stock, the product will be prematurely delisted at time t<T, as shown in block 108A, and the customer will get notified that their order has been cancelled and that they will not receive the product. After the customer's account has been debited, the demand driven algorithm will be run in real-time, as shown in block 110A, in order to update the supply and demand values used to update the price/fulfillment date pairs in block 111A, by way of, but not limited to, any of the following three cases:
Seller uses automated solution, where price and fulfillment date pairing is a linear or non-linear derivative of time, supply, and/or demand. A general step-by-step example of how the algorithm works is provided below, but can be substituted by any statistical or intelligent procedure.
   1. At sale start, semi-randomly generate some price/fulfillment date pairs, using historical data of similar products.
   2. Establish the cost of holding inventory rate and estimate a curve between sale start and a future reference point, this point being sale end or any other infinite future reference point. This curve can be linear, non-linear, flat, or any other shape.
   3. Each time period, t, estimate a subset of miniature curves existing of numerous price/fulfillment date pairs. This can be generated using, but is not limited to, a neural network, and/or classification algorithm, and/or stochastic process to estimate which product fulfillment date best fits a chosen price, using historical pair data or preset pair data, supply and demand surges, or any other related external factors. It can also be aligned with production schemas or inventory depletion schemas.
Seller makes use of different price ranges; a price, submitted by the customer, falls into a certain pre-specified or automatically generated range, each range being assigned to a fixed fulfillment date. Once the fulfillment date has been reached, all orders, associated to said fulfillment date, are fulfilled in order from high to low price. In general, higher price ranges are associated with earlier fulfillment dates.
Seller provides product manufacturing schedules or inventory depletion schedules to be incorporated as a factor into the price/fulfillment date pair generation process in order to adjust price/fulfillment data pairs based on manufacturing/inventory peaks and dips of said schedules.
   The update of price/fulfillment date pairs are performed at discrete intervals between time t₃=0 and t₃=T. At time t=T, the product will be delisted as shown in block 112A.

FIG. 1B illustrates a basic process of an order placement and execution system, without customer order commitment, in one embodiment. A product is listed for sale utilizing the price/fulfillment date generation system and method at time t=0, as shown in block 100B. In block 101B, the price/fulfillment date generation system and method generates the initial price/fulfillment date pairs for the product listed in block 100B. It will be understood that instead of generating price/fulfillment date pairs, either price/fulfillment date range pairs, or price range/fulfillment date pairs, or price range/fulfillment date range pairs could be generated as well. For the purpose of simplicity, hereon after the only case referred to is the case where price/fulfillment date pairs are being generated. In block 102B customers select their preferred price/fulfillment date pair at any time after product listing at time t₁=0 and before product delisting at time t₁=T. Immediately after, the customer is authenticated through, but not limited to, a cell phone number, shipping address or email confirmation, as shown in block 103B. In block 104B, the customer submits the price/fulfillment date pair and optionally provides payment details, providing the customer with the option to buy the product at the fulfillment date/range. Once the customer submits the price/fulfillment date pair, said pair will be added to the open/outstanding orders, as show in block 105B.

At any time between product listing at time t₂=0 and at or after product delisting at time t₂=T+θ, θ being some random time after t₂=T, θε[0,□)εtime, the system and method collects open/outstanding orders for fulfillment at the fulfillment date, or within the fulfillment range, block 106B, whereafter the system and method will perform and inventory availability check, as can be seen in block 107B. The inventory check will check if the product is still available. If the product is not in stock, the product will be prematurely delisted at time t<T, as shown in block 109B, and the customer will get notified that their order has been cancelled and that they will not receive the product. If the product is still in stock, the customer is notified that the product is available at the price they submitted, block 108B, whereafter the customer can decide whether or not to purchase the product at the price he/she submitted, as can be seen in block 110B. If the customer decides to commit and purchase the product, the customer provides his/her payment details, if customer hasn't already done so, and the customer's account is debited, block 112B. If the customer decides not to commit and purchase the product, the open order will be voided, as shown in block 111B. After the customer's account has been debited, the demand driven algorithm will be run in real-time, as shown in block 113B, in order to update the supply and demand values used to update the price/fulfillment date pairs in block 114B, by way of, but not limited to, any of the three bullet point cases mentioned in paragraph [0030].

The update of price/fulfillment date pairs are performed at discrete intervals between time t₃=0 and t₃=T. At time t=T, the product will be delisted as shown in block 115B.

FIG. 1C illustrates a basic process of an order placement and execution system, comprising the customer selecting, with or without order commitment, a price/fulfillment date pair generated by one or more sellers, in one embodiment. A product is listed for sale at time t=0, as shown in block 100C. In block 101C, a customer inputs or selects their preferred price and quantity, and/or any other relevant input information, except fulfillment date information, at any time after product listing at time t₁=0 and before product delisting at time t₁=T. Immediately after, the customer is authenticated through, but not limited to, a cell phone number, shipping address or email confirmation, as shown in block 102C. The inputted or selected price will then be communicated to one or more sellers/merchants through some type of communication means, as can be seen in block 103C. All merchants/sellers will then link back, based on the customer's preferred price and through some type of communication means, their corresponding fulfillment date, shown in block 104C, from which the customer can only view the best fulfillment date, based on his/her preferences, or view the fulfillment date from all sellers from which the customer can select their preferred fulfillment date, as can be seen in block 105C. It will be understood that instead of the seller providing price/fulfillment date pairs, either price/fulfillment date range pairs, or price range/fulfillment date pairs, or price range/fulfillment date range pairs could be provided as well. For the purpose of simplicity, hereon after the only case referred to is the case where price/fulfillment date pairs are being provided. Based on the seller's method of selling preference, the customer can either commit, or just simply submit without committing, his/her preferred price/fulfillment date pair by providing payment details, such as, but not limited to, credit card details, invoices, down payments, as shown in block 105C. It will be understood that if the seller prefers the customer to commit to a price, the system and method has the ability to perform a real-time inventory availability check, block 109C, and debit the customer's account upon inventory availability, block 110C, immediately after the customer commits to the price/fulfillment date pair. Once the customer submits the price/fulfillment date pair either with or without committing, the preferred price/fulfillment date pair will be added to the open/outstanding orders, as show in block 106C.

At any time between product listing at time t₂=0 and at or after product delisting at time t₂=T+θ, θ being some random time after t₂=T, θε[0,∞)εtime, the system and method collects open/outstanding orders for fulfillment at the fulfillment date, or within the fulfillment range, as shown in block 107C, whereafter it will check for each order whether or not the customer's account has been debited, as can be seen in block 108C. If the customer's account has already been debited for the collected open/outstanding order, the open/outstanding order will be fulfilled. If the customer's account has not been debited for the collected open/outstanding order, the system and method will then perform an inventory check, as shown in block 109C. The inventory check will check if the product is still available. If the product is not in stock, the product will be prematurely delisted at time t<T, as shown in block 114C, and the customer will get notified that their order has been cancelled and that they will not receive the product. If the product is still in stock, the system and method will then check whether or not the customer committed to the submitted price/fulfillment date pair, as is shown in block 110C. If the customer committed to his/her preferred price/fulfillment date pair submitted, the customer's account is debited, block 112C. If the customer did not commit to his/her preferred price/fulfillment date pair submitted, the customer gets notified that the product is available at the price they submitted, block 111C, whereafter the customer can decide whether or not to commit and purchase the product at the price he/she submitted. If the customer then decides to commit and purchase the product, the customer's account is debited, as can be seen in block 112C. If the customer does not want to commit and purchase the product, the system and method changes the state of the price/fulfillment date pair from open to void, block 113C. At time t=T, the product will be delisted as shown in block 115C.

FIG. 1D illustrates a basic process of an order placement and execution system, comprising customer order commitment and price/fulfillment date pair generation based on customer's input and seller's inventory levels, in one embodiment. A customer is authenticated through, but not limited to, a cell phone number, shipping address or email confirmation, as shown in block 100D. Once the customer has been authenticated, the customer inputs, amongst others, a price and quantity of the product of interest, block 101D, at any time t during which the product is listed, tε[0,∞)εtime. The inputted information, in combination with historical product data, block 104D, and data retrieved from the seller's inventory management system, such as inventory levels, or manufacturing schedules, or any other relevant product data, block 103D, are then processed by the system by way of comparing the calculated cost of holding inventory with the customer inputted price and the retail price, to generate a fulfillment date, block 102D, that is communicated back to the customer, in real-time, as one price/fulfillment date pair, as shown in block 105D. It will be understood that instead of the system and method generating a price/fulfillment date pair, either a price/fulfillment date range pair, or a price range/fulfillment date pair, or a price range/fulfillment date range pair could be generated as well. For the purpose of simplicity, hereon after the only case referred to is the case where a price/fulfillment date pair is being generated. At this point the customer can decide whether or not he/she is satisfied with the generated price/fulfillment date pair, block 106D. If the customer is satisfied with the generated price/fulfillment date pair, the customer can commit to said price/fulfillment date pair by providing payment details, such as, but not limited to, credit card details, invoices, down payments, as shown in block 107D, whereafter the customer's account is debited, block 108D. If the customer is not satisfied with said price/fulfillment date pair, the customer has the ability to input another price and quantity, amongst others, of the product of interest, block 101D. After the customer's account has been debited after price/fulfillment date pair commitment, the demand driven algorithm will be run in real-time, as shown in block 109D, in order to update the supply and demand values used to generate the price/fulfillment date pairs in block 102D. The fulfillment information along with information inputted by the customer, block 110D, will then be added to the open/outstanding orders, block 112D, and communicated to the seller/manufacturer, block 111D, so that the seller/manufacturer can prepare for the order ahead of the fulfillment date by either increasing their inventory or production. As shown in block 113D, the system and method will notify the seller/manufacturer at the fulfillment date, or at any time before the fulfillment date as specified by the preferences of the seller/manufacturer, that the open order should be fulfilled at the fulfillment date committed to by the customer at block 107D.

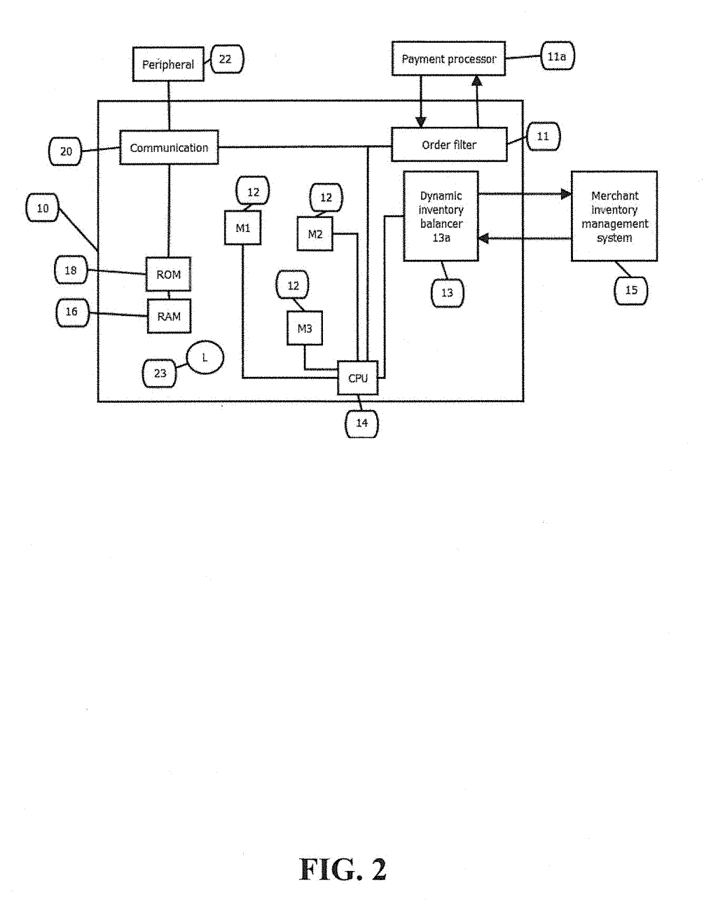

Referring now to FIG. 2, it can be seen that a specific embodiment of a machine 10 is shown as having the capability to run the system and method of the present invention. Machine 10 in a preferred embodiment includes a number of memory storage locations 12 that are capable of storing data, moving data in and out of storage locations, comparing data and allowing the data to be manipulated and then stored again, moved and/or compared. Machine 10 further comprises a central processing unit (CPU) 14, rapid access memory (RAM) 16 and read only memory (ROM) 18. Communications means 20 is provided to allow machine 10 to transact with buyers, sellers, banking systems, credit card systems, networks and peripheral devices 22, such as printers and data entry devices. In the operation of the system and method, such items as selected price/fulfillment date pairs can be received with the communications means 20 or through peripheral connectivity and stored in one memory storage location 12 and its concomitant payment information, in preferred embodiments payment/credit data, can be placed in a separate memory location 12 specifically nominated for payment/credit details. The machine 10 provides a continuous review and movement of details such that price/fulfillment date pairs can be generated and stored to coincide with the present supply and demand of goods and/or services.

It will be understood that the system and method is directed to multiple price/fulfillment date pairs being generated and reviewed over time and these being analyzed and stored in the manner noted in this disclosure. For clarity, while the description may discuss a particular price/fulfillment date pair at a particular time, it will be understood that the illustration here is just for clarity and that each price/fulfillment date pair may be fulfilled or voided/cancelled or amended at any time (in accordance with the teachings of the invention). As time progresses, as determined by machine 10 clock 23, any price/fulfillment date pair, having been entered and stored in a memory 12, can be moved to another memory storage location 12, can be designated by machine 10, as being a stored price/fulfillment data pair. Stored price/fulfillment date pairs, those that currently do not qualify as being in a position to purchase goods and/or services, remain stored and are reviewed at the fulfillment date by the CPU 14, using software in ROM 18, for order fulfillment and where applicable, inventory availability.

In a preferred embodiment of the machine 10, the order filter 11 utilizes the CPU 14 and memory storage locations 12 to determine which orders are due for payment processing, where after it will utilize communication means 20 to transact with the payment processor 11a in order to debit the account of the customer. The result object from the payment processor 11a will then be stored in memory storage locations 12. The order filter 11 utilizes the power of the CPU 14, RAM 16, ROM 18, memory storage locations 12, and communications means 20 to transact with the payment processor 11a.

In a preferred embodiment of the machine 10, the dynamic inventory balancer 13 is provided by providing an inventory storage location 13a into which each price/fulfillment date pair and its status, or a copy of each price/fulfillment date pair and its status, is made available to the merchant inventory management system 15 by either the dynamic inventory load balancer 13 signaling the merchant inventory management system 15 to fulfill the order, or by allowing the merchant inventory management system 15 to retrieve all price/fulfillment date pairs from the inventory storage location 13a, requesting the dynamic inventory balancer 13, at the fulfillment date, permission to fulfill the order. Permission will only be granted after the customer's account has been debited successfully by the order filer 11. The dynamic inventory balancer 13 works by using the power of the CPU 14, RAM 16, ROM 18, and memory storage locations 12 to communicate with merchant inventory management system 15.

As will be described in more detail below, machine 10 will be instrumental in taking data from the sellers and buyers and will compare the data against itself and preceding and subsequent price/fulfillment date pairs, stock, product and/or service demand, present product and/or service value, and other conditions of sales, clock the data to determine chronological changes in conditions, move data from position to position to maintain the data's relevance and its associated purchase information; determining from time to time the creation of a sale, the review of stored price/fulfillment date pairs to determine if a stored price/fulfillment date pair with time can be a valid pair and create sales. The machine, through its peripherals 22 and communication means 20 can then consummate sales and provide receipts and notifications of purchase to the successful buyers. In addition, in some embodiments, the machine 10 can include such peripherals 22 as packaging and mailing devices, return authorization generators, shelving machinery and others that further automate the sales process.

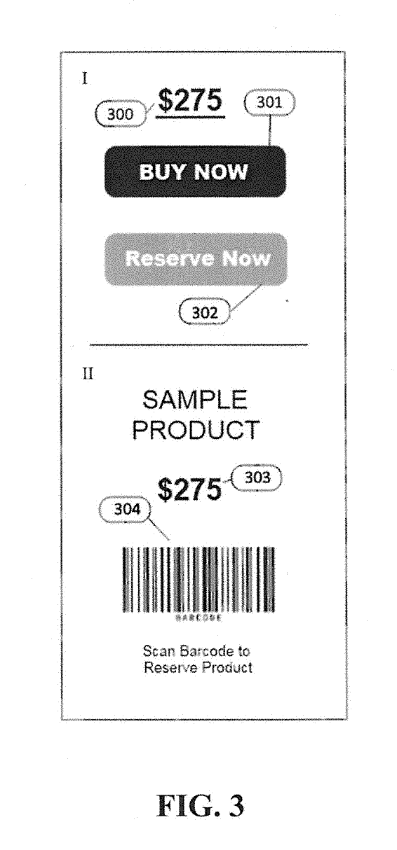

FIG. 3 illustrates a sample graphical user interface of the system and method of the present disclosure for a web page or mobile application split up into two parts; one part for an online merchant (section I) and another part for an offline merchant (section II). Alternative to buying at the fixed price set by the merchant, as shown in block 300, by clicking the “BUY NOW” button, shown in block 301, the customer has the option to reserve the product for a lower price than the fixed price displayed by the merchant, said lower price being set by the customer, by clicking the “Reserve Now” button, as shown in block 302. For offline merchants, block 303 shows an in-store price and block 304, a barcode. In this case, the customer uses a photo camera enabled mobile device to scan the barcode in order to reserve the product at his/her preferred price/date fulfillment date pair.

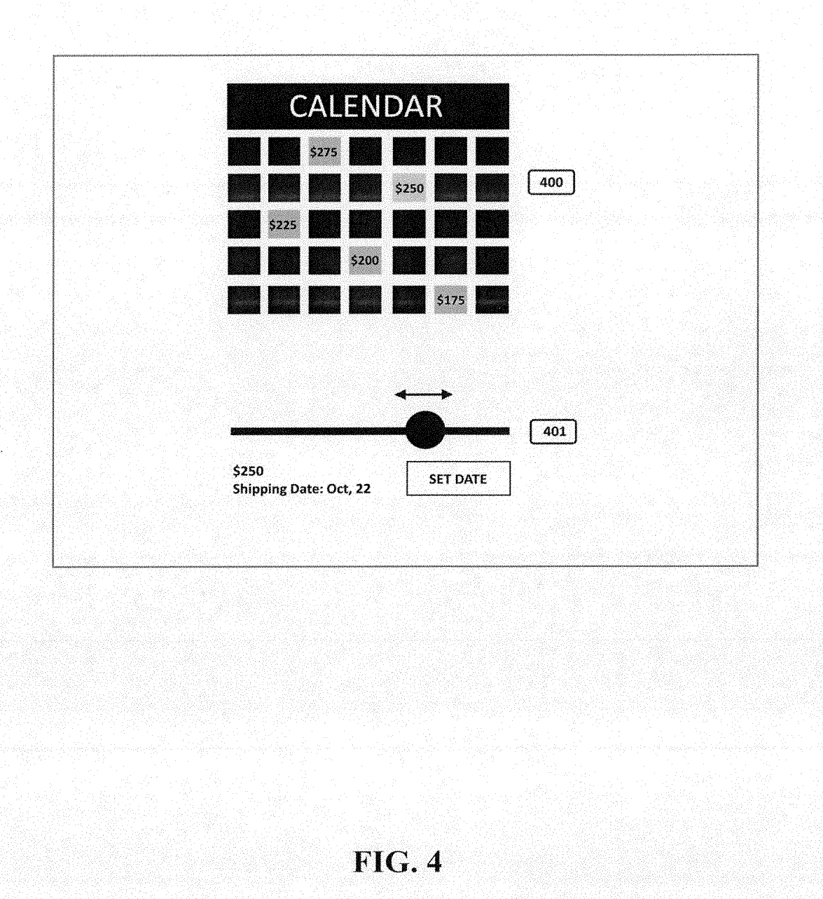

FIG. 4 illustrates a sample price/fulfillment date pair input screen of the system and method of the present disclosure for either a webpage or mobile application after the customer has activated or “clicked” the “Reserve Now” button, block 302, or scanned the barcode with a photo camera enabled mobile device, block 304, of FIG. 3. FIG. 4 shows the customer having the option to input a preferred price in an, but not limited to, input box, price/fulfillment date calendar, block 400, or price/fulfillment date slider, block 401. Block 400 and 401 show per price a fulfillment date, this fulfillment date indicating the amount of time the customer has to wait before the good and/or service is being fulfilled at his/her inputted preferred price, inventory permitting. By “clicking” on the fulfillment date on the calendar of block 400, or the “Set Date” button of block 401, the customer confirms his/her preferred price and proceeds towards a standardized checkout process.

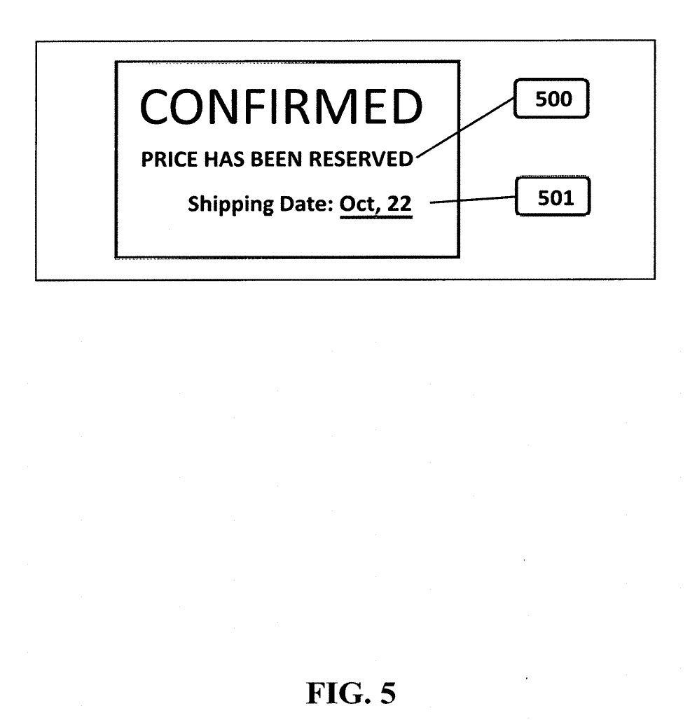

FIG. 5 illustrates a sample reserved order confirmation screen of the system and method of the present disclosure for either a webpage or mobile application where the customer receives a confirmation that his/her preferred price/fulfillment date pair has been submitted and stored, as shown in block 500. Block 501 shows the preferred price/fulfillment date pair selected by the buyer and any other standard conditions.

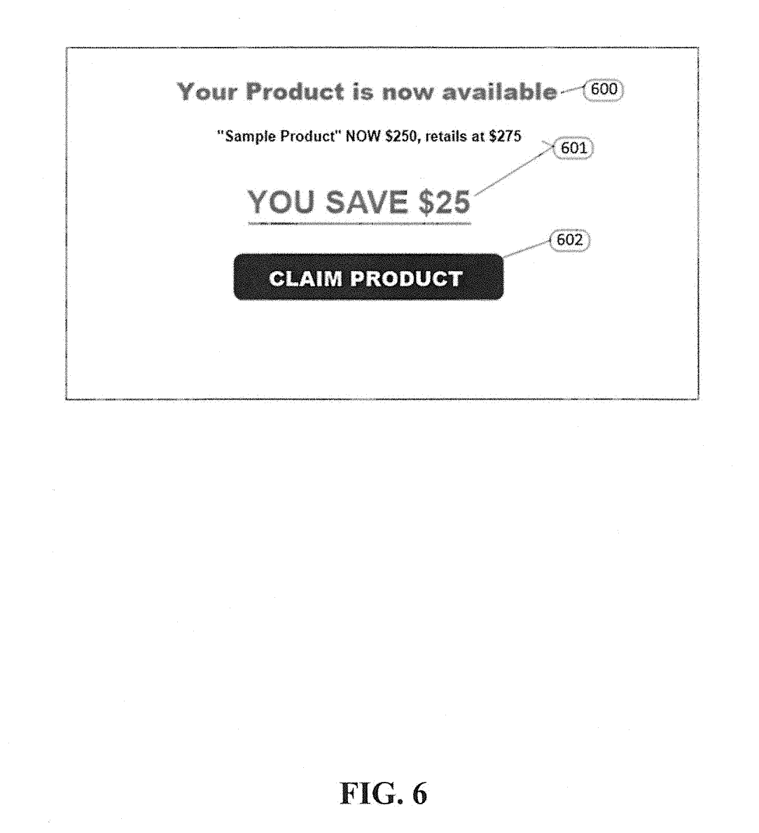

FIG. 6 illustrates a sample product availability customer notification screen of the system and method of the present disclosure for either a webpage or mobile application where the customer has the option to buy the product at the fulfillment date, as described in block 110B of FIG. 1B. At the fulfillment date, the customer is notified he/she can purchase the good and/or service at his/her preferred price, as shown in block 600. Block 601 displays any benefits to the customer by purchasing the product at his/her preferred price. Block 602 shows the clickable button which takes the customer to a standardized checkout process where he/she commits to the purchase by entering their shipping data and payment details for payment processing.

Although the description above contains many specifics, these should not be construed as limiting the scope of the embodiments but as merely providing illustrations of some of several embodiments. For example, the system can also be applied outside of e-commerce, using a mobile website or mobile application for a prospective buyer to select their preferred price/fulfillment date pair while physically being present inside or near a brick and mortar store. The system does also not depend on the calculation methods presented, for example, instead of a classification method being used to generate price/fulfillment date pairs, a neural network can be used. Furthermore, different approaches to prospective buyer demand impact can be used; instead of demand elasticity one can model the demand peaks over time leading to a change in price/fulfillment date pair values. Indeed, it will be understood that while formulas and algorithms are mentioned and employed, the invention should also be viewed for the movement of data and payment information within a machine that does many steps to compare, choose, vet, store and many other functions that are beyond an abstract idea or formula.

It is contemplated that the parts and features of any one of the embodiments described can be interchanged with the parts and features of any other of the embodiments without departing from the scope of the present disclosure. The foregoing description discloses and describes merely exemplary embodiments of the present disclosure and is not intended to be exhaustive or to limit the disclosure to the precise form disclosed. As will be understood by those skilled in the art, the disclosure may be embodied in other specific forms, or modified or varied in light of the above teachings, without departing from the spirit, novelty or essential characteristics of the present disclosure. Accordingly, the scope of the embodiments should be determined by the appended claims and their legal equivalents, rather than by the examples given.

### CONCLUSION, RAMIFICATIONS AND SCOPE

Accordingly, the reader will see that the various embodiments of the order placement and execution process utilizing an advanced fulfillment date/price generation system, as used with the machine disclosed, can be used to buy and sell a plurality of homogeneous goods and/or services from one or more sellers to one or more buyers at optimized prices over time, leading to inventory management optimization and improved inventory clearing rates as a result thereof. Moreover, the flexible fulfillment date/price process is fully automated with regard to price/fulfillment date generation, payment processing, and order execution, saving the seller of the good and/or service time and resources. The approach has additional advantages in that:
The system and method creates an interactive shopping experience for the customer; keeping the customer involved in the pricing process of the good and/or service results in higher customer conversion rates.
The system and method allows for full transparency in terms of price and fulfillment date, providing customers with a sense of security.
The system and method is able to capture superior pricing data on a per product basis, which can be utilized for improved current or future sale generation.
The system and method is able to adjust short and long term production schedules and/or inventory depletion schedules based on short and long term guaranteed sales.
The system and method allows for an optimized markdown process, where each customer has its own personalized markdown price and markdown fulfillment date.
The system and method inherently creates, in a demand driven market, competition between prospective buyers in terms of fulfillment dates as opposed to price being the leading factor in the purchase decision.
The system and method is able to process and sell returned goods before said goods enter the warehouse.

What is claimed is:

1. A system and method for providing one or more sellers the ability to sell a plurality of homogeneous goods and/or services to one or more buyers, comprising:
a. a machine comprising a central processing unit (CPU), rapid access memory (RAM), read only memory (ROM), a plurality of data storage locations, communications means, and peripherals, wherein the machine is capable of generating, receiving, and storing of a plurality of price/fulfillment date pairs, price/fulfillment date range pairs, price range/fulfillment date pairs, price range/fulfillment date range pairs, and their associated payment information, communicating with external systems, and
b. said buyers selecting said price/fulfillment date pairs, price/fulfillment date range pairs, price range/fulfillment date pairs, price range/fulfillment date range pairs, of said goods and/or services and inputting payment credentials into the machine whereupon each said price/fulfillment date pairs, price/fulfillment date range pairs, price range/fulfillment date pairs, price range/fulfillment date range pairs are stored in one of said data storage locations and the associated payment information is stored at a payment information detail storage location, and
c. real-time processing of one or more submitted orders, by said buyers, to be stored in one or more of said data storage locations for future fulfillment, and
d. transmitting of one or more unfulfilled orders to said sellers for fulfillment at or before the fulfillment date, until either inventory of said goods and/or services are sold out, or said goods and/or services are no longer listed by said sellers.

2. The invention of claim 1, wherein the machine is one or more machines.

3. The invention of claim 1, wherein the fulfillment date comprises delivery date, shipping date, and pick-up date.

4. The invention of claim 1, whereby the system and method generates said price/fulfillment date pairs, price/fulfillment date range pairs, price range/fulfillment date pairs, price range/fulfillment date range pairs, using, but not limited to, classification methods, neural networks, stochastic forecasting methods.

5. The invention of claim 1, whereby the system and method congregates said unfulfilled orders, and distributes said unfulfilled orders to said sellers for informative purposes.

6. The invention of claim 1, whereby said buyers select a price/fulfillment date pair, or a price/fulfillment date range pair, or a price range/fulfillment date pair, or a price range/fulfillment date range pair, utilizing, but not limited to, a price slider, or a price calendar, or a price input box.

7. The invention of claim 1, whereby said buyers, who have committed to the purchase at the time of order placement, will not receive the good and/or service from the seller at the fulfillment date if the good and/or service is out of inventory at the fulfillment date.

8. The invention of claim 1, whereby said buyers are guaranteed to receive the good and/or service at said buyers their selected fulfillment date only after it has been determined that inventory of the good and/or service is available at said buyers their time of order commitment and said buyers their account has been debited.

9. The invention of claim 1, whereby said buyers do not commit to the purchase at the time of an order placement, but have the ability to commit to the purchase at any time between said order placement and the order fulfillment date, at said buyers their submitted price at time of said order placement.

10. The invention of claim 1, whereby the system and method is capable of notifying said sellers their inventory management system at said buyers their selected fulfillment date or at any other time prior to the fulfillment date.

11. The invention of claim 1, whereby the fulfillment date is being generated based on the inputted price of the buyer, historical product data, historical sales data, and inventory and/or production related information.

12. The invention of claim 1, whereby the system and method is capable of collecting a payment at the order placement, or at the product fulfillment, or any other time between the order placement and the product fulfillment.

13. The invention of claim 1, whereby the buyer does not commit to a payment of the order, the seller may require a down payment or a small one-time non-refundable payment amount.

14. The invention of claim 1, further comprising a standalone software system for use in a third party merchant/supplier/e-commerce website as an embedded additional feature of the website.

15. The invention of claim 1, whereby the system and method is configured for use in a brick and mortar store, through a mobile application and/or a mobile web portal.

16. The invention of claim 1, whereby said buyers have the option to increase the previously selected price as to obtain an earlier product fulfillment date.

17. The invention of claim 1, whereby generation of said price/fulfillment date pairs, price/fulfillment date range pairs, price range/fulfillment date pairs, price range/fulfillment date range pairs of the good and/or service is continuously changing based on supply, customer demand, and cost of holding inventory.

18. The invention of claim 1, whereby generation of said price/fulfillment date pairs, price/fulfillment date range pairs, price range/fulfillment date pairs, price range/fulfillment date range pairs of the good and/or service is continuously changing based on production schedules, inventory levels, raw material prices, and seasonal demand.

19. The invention of claim 1, wherein said payment information is required to authenticate the buyer and said payment information comprises of one or more of credit card information, bank routing and account information, or any other third party payment service information.
